(19) United States
(12) Patent Application Publication
(10) Pub. No.: US 2016/0138751 A1
(43) Pub. Date: May 19, 2016

(54) SUPPORTING ASSEMBLY

(71) Applicants: Inventec (Pudong) Technology Corporation, Shanghai (CN); INVENTEC CORPORATION, Taipei City (TW)

(72) Inventors: Chiu-Chih LEE, TAIPEI CITY (TW); Wei-Han HSUEH, TAIPEI CITY (TW)

(21) Appl. No.: 14/690,487

(22) Filed: Apr. 20, 2015

(30) Foreign Application Priority Data
Nov. 18, 2014 (CN) 201410658367.2

(51) Int. Cl. F16M 11/02; G06F 1/16

(52) U.S. Cl. CPC F16M 11/02; G06F 1/16

(57) ABSTRACT

A supporting assembly includes a base plate and a supporting stand. The base plate has a first surface. The supporting stand includes a base and a supporting portion. The base is detachably connected with the first surface and has a second surface away from the first surface. The supporting portion is connected with the second surface and has a third surface that is away from the base and is configured to abut against a top cover.

### RELATED APPLICATIONS

This application claims priority to Chinese Application Serial Number 201410658367.2, filed Nov. 18, 2014, which is herein incorporated by reference.

### BACKGROUND

1. Technical Field

The present disclosure relates to supporting assemblies. More particularly, the present disclosure relates to supporting assemblies used for electronic devices.

2. Description of Related Art

With the advancement of technology, new generation of electronic devices, such as personal computers, laptop computers and tablet computers, have to exhibit some market-acceptable key factors like the enhancement of the functions and operation speeds as well as lightweight appearance.

It is a common technical solution in the industry by using simple structure to control the dimensions of an electronic device, including the maintenance of distance between the casings by a stand. Nevertheless, since the size and dimension of the stand is becoming compact with the lightweight appearance, while abutting and supporting the casing, it may also likely exert a concentrated impact force against the casing in case of the collision of the electronic device, and cause a local deformation as a bulge on the casing.

### SUMMARY

A technical aspect of the present disclosure provides a supporting assembly, which allows the user to easily change supporting stands of different sizes. Thus, the reaction force that the supporting stand exerts on the top cover can be distributed, so as to reduce the chance of the deformation of the top cover due to the over-concentration of the reaction force exerting on the top cover by the supporting stand.

According to an embodiment of the present disclosure, a supporting assembly includes a base plate and a supporting stand. The base plate has a first surface. The supporting stand includes a base and a supporting portion.

The base is detachably connected with the first surface and has a second surface away from the first surface. The supporting portion is connected with the second surface and has a third surface that is away from the base and is configured to abut against a top cover.

In one or more embodiments of the present disclosure, the third surface is a flat surface and is substantially parallel with the first surface.

In one or more embodiments of the present disclosure, the supporting assembly further includes at least one first latching portion protruded from the first surface. The first latching portion abuts against an end of the base, so as to restrict the freedom of movement of the supporting stand towards the first latching portion relative to the base plate.

In one or more embodiments of the present disclosure, the first latching portion further includes a main body and a cover body. The main body is connected with the first surface, and is configured to abut against the end of the base. The cover body is connected with an end of the main body away from the first surface and has an abutting surface facing the base plate. The abutting surface is configured to abut against the second surface, so as to prevent the supporting stand from moving away from the base plate in a direction away from the base plate.

In one or more embodiments of the present disclosure, the first latching portion further has a first guiding structure located on the cover body. The base has a second guiding structure located on the second surface, and the second guiding structure is latched to the first guiding structure towards the first latching portion.

In one or more embodiments of the present disclosure, the first guiding structure is a recess and the second guiding structure is a bump.

In one or more embodiments of the present disclosure, the supporting stand further includes a locking portion located on an end of the base away from the end abutting against the first latching portion. The base has a locking hole located relative to the locking portion. The locking portion extends towards the locking hole and abuts against an inner edge of the locking hole facing the first latching portion, so as to fix the relative position of the supporting stand and the base plate.

In one or more embodiments of the present disclosure, the base further has a through hole communicated with the second surface. The supporting assembly further includes at least one second latching portion protruded from the first surface. The second latching portion passes through the through hole and abuts against an inner edge of the through hole, so as to restrict the freedom of movement of the supporting stand towards the second latching portion relative to the base plate.

In one or more embodiments of the present disclosure, the supporting assembly further includes a pair of limiting portions located on the first surface, and the base is movable between the limiting portions.

In one or more embodiments of the present disclosure, the supporting portion has a space and a reinforcing structure. The reinforcing structure is located in the space and connected with an inner wall of the supporting portion.

When compared with the prior art, the embodiments of the present disclosure mentioned above have at least the following advantages:

(1) Since the base of the supporting stand is detachably connected with the first surface of the base plate, the user can simply and easily change the supporting stands of different sizes according to different requirements.

(2) The user can change to use the supporting stand with the third surface of a larger area. Thus, the reaction force exerting on the top cover by the supporting stand can be distributed, and the chance of the deformation of the top cover due to the over-concentration of the reaction force exerting on the top cover by the supporting stand is reduced.

(3) When the supporting stand is detached from the base plate, it is required that the user tilts up the locking portion in the direction away from the base plate. Thus, the supporting stand is not easily loosened from the base plate.

### BRIEF DESCRIPTION OF THE DRAWINGS

The disclosure can be more fully understood by reading the following detailed description of the embodiments, with reference made to the accompanying drawings as follows:

FIG. 1 is a plan view of a supporting assembly according to an embodiment of the present disclosure;

FIG. 2 is a sectional view along the section line A-A of FIG. 1, in which the supporting stand abuts against a top cover; and

FIG. 3 is a sectional view along the section line B-B of FIG. 2.

### DETAILED DESCRIPTION

Drawings will be used below to disclose a plurality of embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

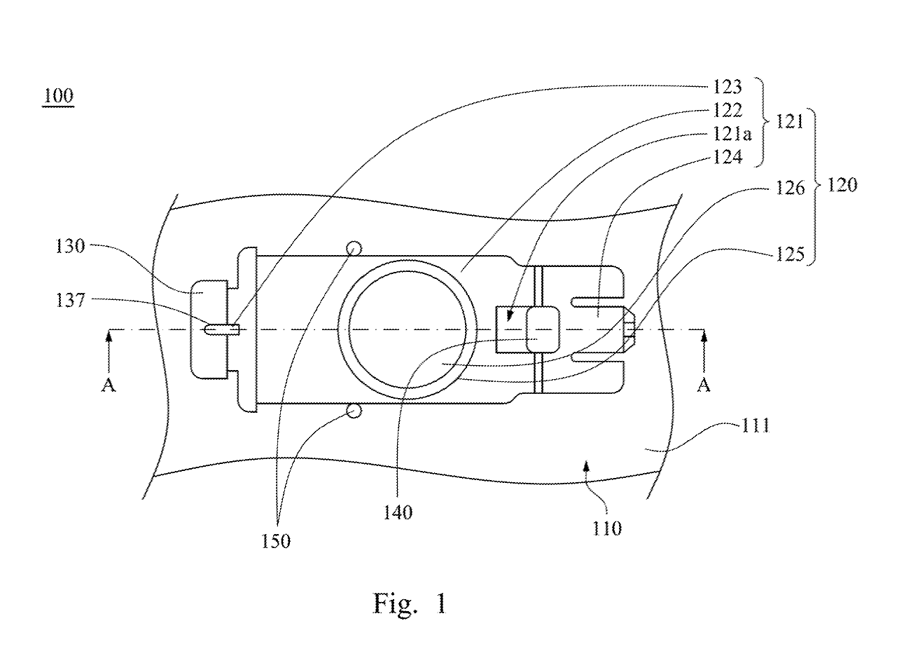

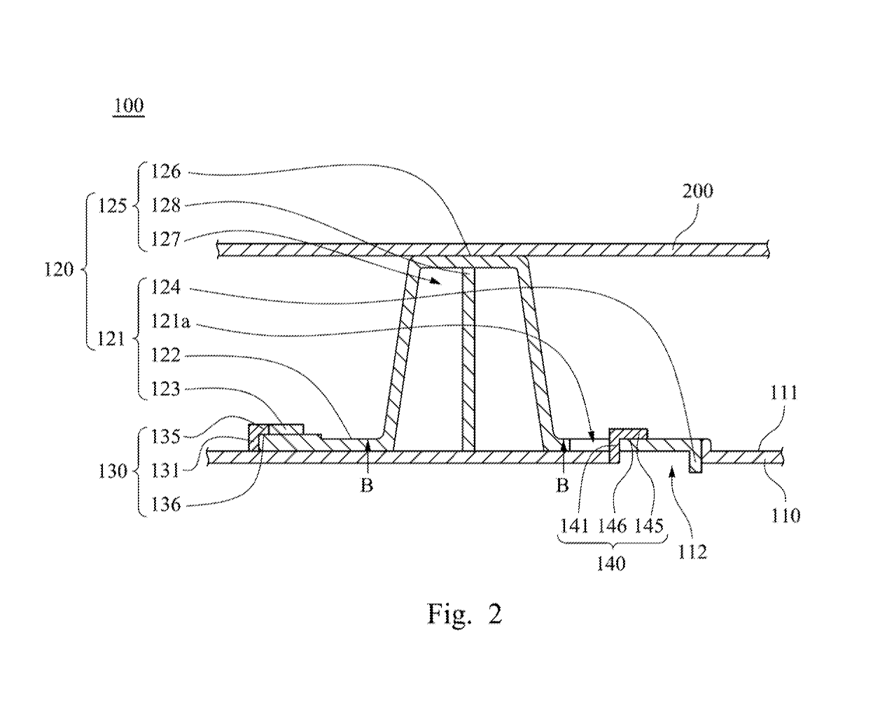

Please refer to FIGS. 1-2. FIG. 1 is a plan view of a supporting assembly 100 according to an embodiment of the present disclosure. FIG. 2 is a sectional view along the section line A-A of FIG. 1, in which the supporting stand 120 abuts against a top cover 200. As shown in FIGS. 1-2, a supporting assembly 100 includes a base plate 110 and a supporting stand 120. The base plate 110 has a first surface 111. The supporting stand 120 includes a base 121 and a supporting portion 125. The base 121 is detachably connected with the first surface 111. The base 121 has a second surface 122 away from the first surface 111. The supporting portion 125 is connected with the second surface 122. The supporting portion 125 has a third surface 126 that is away from the base 121. The third surface 126 is configured to abut against the top cover 200.

In other words, by the abutting of the third surface 126 of the supporting assembly 100 against the top cover 200, the distance between the top cover 200 and the first surface 111 of the base plate 110 is fixed. Moreover, since the base 121 of the supporting stand 120 is detachably connected with the first surface 111, this means, the user can simply and easily change the supporting stands 120 of different sizes according to different requirements. For example, when the supporting stand 120 abuts against the top cover 200 and bears a relatively large force from the top cover 200, the user can change to use the supporting stand 120 with the third surface 126 of a larger area. In this way, the reaction force exerting on the top cover 200 by the supporting stand 120 can be distributed, and the chance of the deformation of the top cover 200 due to the over-concentration of the reaction force exerting on the top cover 200 by the supporting stand 120 is reduced.

In order to further distribute the reaction force exerting on the top cover 200 by the supporting stand 120, in this embodiment, the third surface 126 is a flat surface and is substantially parallel with the first surface 111. In this way, being parallel with the first surface 111 as well, the top cover 200 can abut against the third surface 126 more evenly, such that the reaction force exerting on the top cover 200 by the supporting stand 120 is further distributed.

In addition, as shown in FIGS. 1-2, the supporting assembly 100 further includes at least one first latching portion 130. The first latching portion 130 is protruded from the first surface 111. Moreover, the first latching portion 130 abuts against an end of the base 121, so as to restrict the freedom of movement of the supporting stand 120 towards the first latching portion 130 relative to the base plate 110.

To be more specific, the first latching portion 130 further includes a main body 131 and a cover body 135. The main body 131 is connected with the first surface 111, and is configured to abut against the end of the base 121. The cover body 135 is connected with an end of the main body 131 away from the first surface 111. The cover body 135 has an abutting surface 136 facing the base plate 110. The abutting surface 136 is configured to abut against the second surface 122, so as to prevent the supporting stand 120 from moving away from the base plate 110 in a direction away from the base plate 110.

In order to guide the supporting stand 120 when it is installed to the base plate 110 or detached from the base plate 110, the first latching portion 130 further has a first guiding structure 137. The first guiding structure 137 is located on the cover body 135. In contrast, the base 121 has a second guiding structure 123. The second guiding structure 123 is located on the second surface 122. When the supporting stand 120 is installed to the base plate 110, the second guiding structure 123 is latched to the first guiding structure 137 towards the first latching portion 130, such that the installation of the supporting stand 120 relative to the base plate 110 is guided towards the first latching portion 130. Similarly, when the supporting stand 120 is detached from the base plate 110, the second guiding structure 123 is detached from the first guiding structure 137 in a direction away from the first latching portion 130, such that the detachment of the supporting stand 120 relative to the base plate 110 is also guided in the direction away from the first latching portion 130. In this embodiment, the first guiding structure 137 is a recess and the second guiding structure 123 is a bump. However, this does not intend to limit the present disclosure.

Furthermore, as shown in FIG. 1, the supporting assembly 100 further includes a pair of limiting portions 150. The limiting portions 150 are located on the first surface 111, and the base 121 is movable between the limiting portions 150. In this embodiment, the limiting portions 150 are located at two opposite sides of the base plate 110. When the supporting stand 120 is installed to the base plate 110 or detached from the base plate 110, the base 121 moves between the limiting portions 150. As a result, the installation or the detachment of the supporting stand 120 relative to the base plate 110 is further guided.

Moreover, as shown in FIGS. 1-2, the supporting stand 120 further includes a locking portion 124 located on an end of the base 121 away from the end abutting against the first latching portion 130. The base 110 has a locking hole 112. The locking hole 112 is located relative to the locking portion 124. The locking portion 124 extends towards the locking hole 112. Thus, when the main body 131 of the first latching portion 130 abuts against the end of the base 121, the locking portion 124 of the base 121 also abuts against an inner edge of the locking hole 112 facing the first latching portion 130, such that apart from the restriction of the freedom of movement of the supporting stand 120 towards the first latching portion 130 relative to the base plate 110 as mentioned above, the freedom of movement of the supporting stand 120 away from the first latching portion 130 is also restricted by the abutting of the locking portion 124 against the inner edge of the locking hole 112. As a result, the relative position of the supporting stand 120 and the base plate 110 is fixed.

When the user detaches the supporting stand 120 from the base plate 110, the user can tilt up the locking portion 124 in a direction away from the base plate 110, such that the locking portion 124 does not abut against the inner edge of the locking hole 112 anymore. In this way, the locking portion 124 is not restricted by the inner edge of the locking hole 112, and the supporting stand 120 can be detached from the base plate 110 in the direction away from the first latching portion 130. When the supporting stand 120 is detached from the base plate 110, it is required that the user tilts up the locking portion 124 in the direction away from the base plate 110. Thus, the supporting stand 120 is not easily loosened from the base plate 110.

Furthermore, the base 121 further has a through hole 121a. The through hole 121a is communicated with the second surface 122. The supporting assembly 100 further includes at least one second latching portion 140. The second latching portion 140 is protruded from the first surface 111. The second latching portion 140 passes through the through hole 121a and abuts against an inner edge of the through hole 121a, so as to restrict the freedom of movement of the supporting stand 120 towards the second latching portion 140 relative to the base plate 110. In this embodiment, both the first latching portion 130 and the second latching portion 140 abut against the base plate 110 in the same direction, such that the freedom of movement of the supporting stand 120 towards the first latching portion 130 relative to the base plate 110 is further restricted.

Similarly, the second latching portion 140 further includes a main body 141 and a cover body 145. The main body 141 is connected with the first surface 111, and is configured to abut against the base 121. The cover body 145 is connected with an end of the main body 141 away from the first surface 111. The cover body 145 has an abutting surface 146 facing the base plate 110. The abutting surface 146 is configured to abut against the second surface 122, so as to prevent the supporting stand 120 from moving away from the base plate 110 in a direction away from the base plate 110.

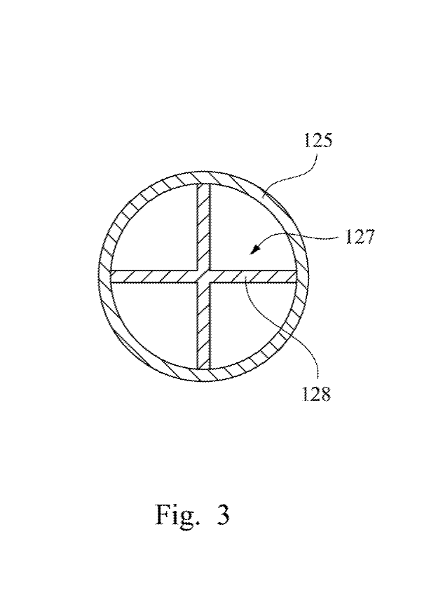

Please refer to FIG. 3. FIG. 3 is a sectional view along the section line B-B of FIG. 2. As shown in FIG. 3, the supporting portion 125 has a space 127 and a reinforcing structure 128. The reinforcing structure 128 is located in the space 127 and is connected with an inner wall of the supporting portion 125. By this design of the reinforcing structure 128 located in the space 127, without affecting the strength of the supporting portion 125, the amount of material used for manufacturing the supporting portion 125 is effectively reduced, and thus the manufacturing cost for the mass production of the supporting portions 125 is also reduced.

In summary, when compared with the prior art, the embodiments of the present disclosure mentioned above have at least the following advantages:

(1) Since the base of the supporting stand is detachably connected with the first surface of the base plate, the user can simply and easily change the supporting stands of different sizes according to different requirements.

(2) The user can change to use the supporting stand with the third surface of a larger area. Thus, the reaction force exerting on the top cover by the supporting stand can be distributed, and the chance of the deformation of the top cover due to the over-concentration of the reaction force exerting on the top cover by the supporting stand is reduced.

(3) When the supporting stand is detached from the base plate, it is required that the user tilts up the locking portion in the direction away from the base plate. Thus, the supporting stand is not easily loosened from the base plate.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure.

In view of the foregoing, it is intended that the present disclosure cover modifications and variations of the present disclosure provided they fall within the scope of the following claims.

What is claimed is:

1. A supporting assembly, comprising:
a base plate having a first surface; and
a supporting stand, comprising:
a base detachably connected with the first surface and having a second surface away from the first surface; and
a supporting portion connected with the second surface and having a third surface that is away from the base and is configured to abut against a top cover.

2. The supporting assembly of claim 1, wherein the third surface is a flat surface and is substantially parallel with the first surface.

3. The supporting assembly of claim 1, further comprising at least one first latching portion protruded from the first surface, wherein the first latching portion abuts against an end of the base so as to restrict the freedom of movement of the supporting stand towards the first latching portion relative to the base plate.

4. The supporting assembly of claim 3, wherein the first latching portion further comprises:
a main body connected with the first surface and configured to abut against the end of the base; and
a cover body connected with an end of the main body away from the first surface and having an abutting surface facing the base plate, wherein the abutting surface is configured to abut against the second surface so as to prevent the supporting stand from moving away from the base plate in a direction away from the base plate.

5. The supporting assembly of claim 4, wherein the first latching portion further has a first guiding structure located on the cover body, the base has a second guiding structure located on the second surface, and the second guiding structure is latched to the first guiding structure towards the first latching portion.

6. The supporting assembly of claim 5, wherein the first guiding structure is a recess and the second guiding structure is a bump.

7. The supporting assembly of claim 3, wherein the supporting stand further comprises a locking portion located on an end of the base away from the end abutting against the first latching portion, the base has a locking hole located relative to the locking portion, and the locking portion extends towards the locking hole and abuts against an inner edge of the locking hole facing the first latching portion, so as to fix the relative position of the supporting stand and the base plate.

8. The supporting assembly of claim 1, wherein the base further has a through hole communicated with the second surface, the supporting assembly further comprises at least one second latching portion protruded from the first surface, wherein the second latching portion passes through the through hole and abuts against an inner edge of the through hole, so as to restrict the freedom of movement of the supporting stand towards the second latching portion relative to the base plate.

9. The supporting assembly of claim 1, further comprising a pair of limiting portions located on the first surface, and the base movable between the limiting portions.

10. The supporting assembly of claim 1, wherein the supporting portion has a space and a reinforcing structure that is located in the space and connected with an inner wall of the supporting portion.
